(19) United States
(12) Patent Application Publication
(10) Pub. No.: US 2006/0072981 A1
(43) Pub. Date: Apr. 6, 2006

(54) Fixing device with a clip

(76) Inventors: Denis Bros, La Queue en brie (FR); Frederique Lemesre, Torcy (FR)

Correspondence Address: Blakely Sokoloff Taylor & Zafman, 12400 Wilshire Boulevard, 7th Floor, Los Angeles, CA, 90025, US

(21) Appl. No.: 10/545,335

(22) PCT Filed: Feb. 19, 2003
(86) PCT No.: PCT/FR03/00549

§ 371 Date: Aug. 11, 2005

(51) Int. Cl. F16B 39/00

(52) U.S. Cl. 411/170

(57) ABSTRACT

The present invention relates to a fastener device comprising a clip (200) and a fastener element (100), the clip (200) being formed by a main plate (210) and a backing plate (220) interconnected by a connection strip (230), and the fastener element (100) comprising a tube (110) secured to the main plate (210) and provided with an internal channel (120), the device being characterized by the fact that, at rest, the backing plate (220) is of non-rectilinear shape being convex towards the tube (110).

The present invention relates to the field of fastener devices.

Still more precisely, the present invention relates to the field of clip-on nuts designed to unite and fasten together two parts.

Numerous embodiments of such clip-on nuts are known.

In this respect, reference may be made for example to the following documents: FR-A-1 488 114, FR-A-2 489 903, FR-A-2 669 384, FR-A-2 670 254, FR-A-2 679 302, FR-A-2 698 134, FR-A-2 749 356, FR-A-2 719 345, FR-A-2 713 726, FR-A-2 715 697, FR-A-2 697 060, FR-A-2 649 454, FR-A-2 627 554, FR-A-2 626 329, U.S. Pat. No. 2,771,113, U.S. Pat. No. 4,729,706, U.S. Pat. No. 4,826,375, GB-A-1 106 905, GB-A-0 802 435, GB-A-2 099 099, EP-A-0 353 468, EP-A-0 220 526, DE-A-88 13 031, DE-A-1 625 275.

As their name indicates, clip-on nuts comprise both a clip and a fastener nut.

The function of the fastener nut is to receive and hold a complementary fastener member such as a screw, a bolt, a pin, or equivalent means. In most cases it is generally cylindrical in shape being provided with an internal channel or an indentation formed in a limb of the clip.

The function of the clip is to preposition and retain the device on one of the parts prior to the fastener member being put into place. It generally comprises two plates for placing on respective opposite sides of the part in question, and interconnected by a connection strip. One of the two plates carries the nut.

In order to fasten two parts together using a clip-on nut, the procedure is generally as follows.

The clip-on nut is clipped onto a first part. The second part is placed in register therewith. Then the complementary fastener member, e.g. a screw, is engaged in both parts and is held stationary in the nut.

Known clip-on nuts have already given good service. However they do not always give complete satisfaction.

In particular, most known clip-on nuts can be used only with parts of thickness lying within a narrow range, and/or they do not always make it possible to guarantee that the two parts are closely parallel.

An object of the present invention is to propose a novel clip-on nut presenting performance better than that of previously known clip-on nuts, and in particular making it possible to avoid any problem of the material from which the nut is made suffering from creep.

In the context of the present invention, this object is achieved by a fastener device comprising a clip and a fastener element, the clip being formed by a main plate and a backing plate interconnected by a connection strip, and the fastener element comprising a tube secured to the main plate and provided with an internal channel, the device being characterized by the fact that, at rest, the backing plate is of non-rectilinear shape being convex towards the tube.

According to another characteristic of the present invention, the backing plate is advantageously adapted to accept deformation into the plane state under mechanical stress.

Other characteristics, objects, and advantages of the present invention appear on reading the following detailed description with reference to the accompanying drawings given by way of non-limiting example, and in which:

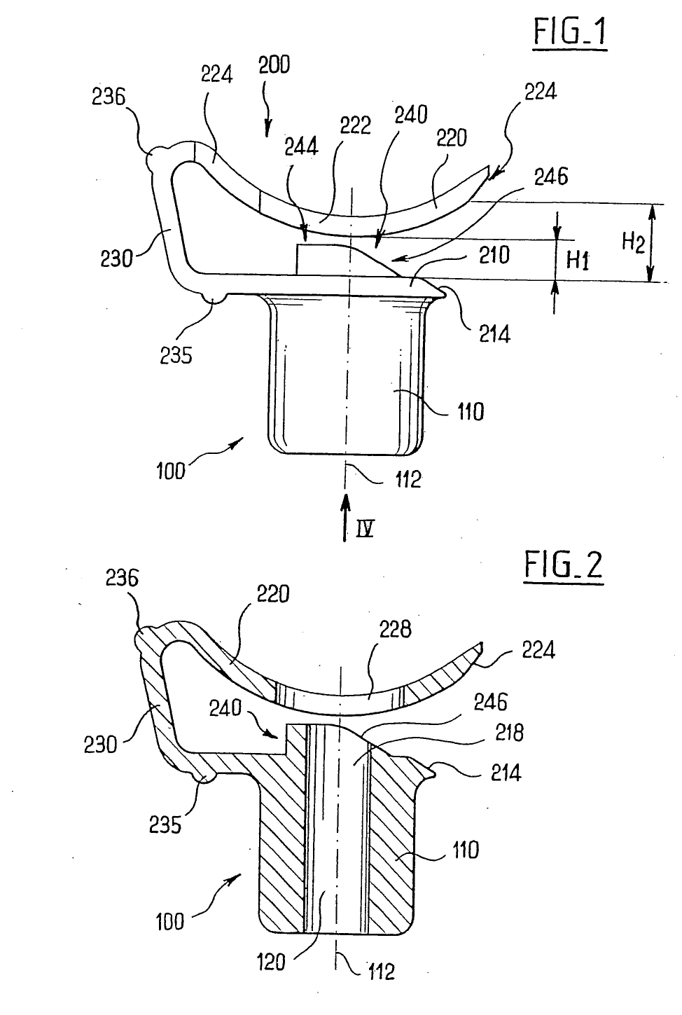

FIG. 1 is a first side view of a device in accordance with a preferred embodiment of the present invention;

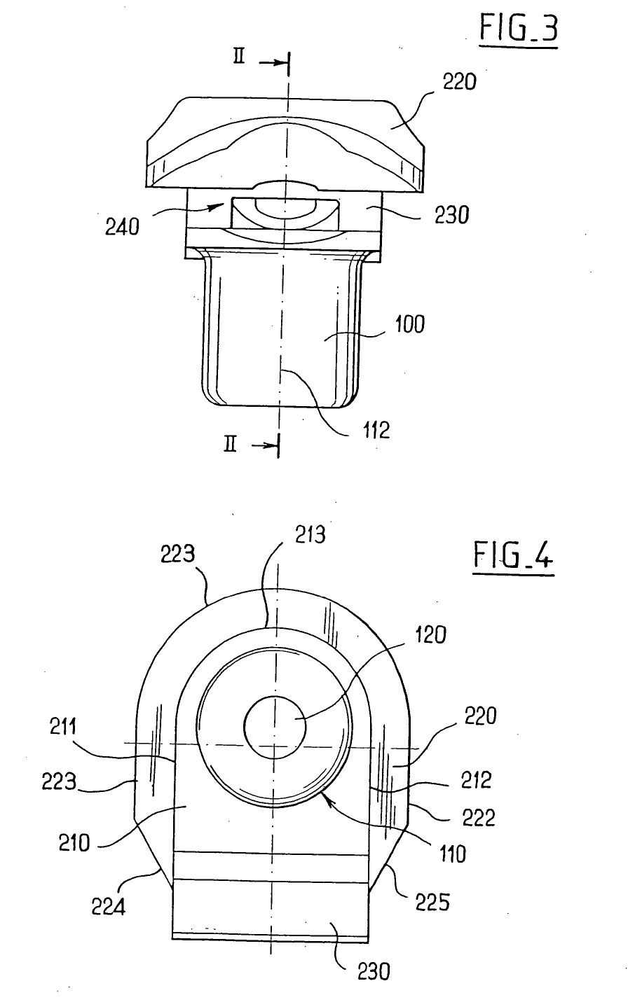

FIG. 2 is a section view of the same device on a section plane referenced II-II in FIG. 3;

FIG. 3 is a second side view of the same device, orthogonal to the view of FIG. 1;

FIG. 4 is an end view of the same device looking along an arrow referenced IV in FIG. 1;

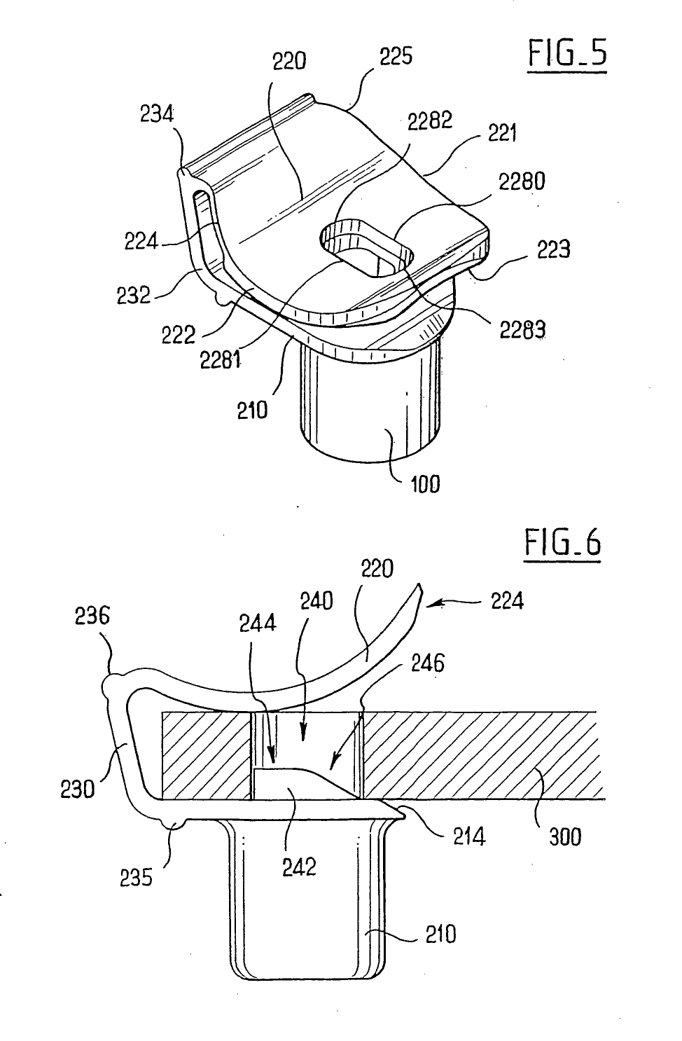

FIG. 5 is a perspective view of the device;

FIGS. 6 to 8 are diagrams showing three successive steps in fastening together two parts with the help of a fastener device in accordance with the present invention;

FIG. 9 is an end view of a device in accordance with the present invention positioned on a part for fastening; and

FIG. 10 is a similar view after the device has pivoted relative to the edge of the part, for space-saving purposes.

The clip-on nut of the present invention shown in the accompanying figures essentially comprises a fastener element 100 and a clip 200.

It is preferably constituted by a single molding of plastics material, e.g., but in non-limiting manner, of polyoxymethylene, or of polyamide 6.6.

The material constituting the device and the diameter of the nut are preferably adapted to make it possible for the fastener member to be mounted and dismounted several times (typically about ten to 15 times).

The material constituting the device must also be adapted to allow elastic deformation to take place locally in its hinge zones, as described below.

The fastener element 100 may be embodied in numerous ways.

In the preferred embodiment shown in the accompanying figures, it comprises a tube 110 centered on an axis 112.

The clip 200 may also be embodied in numerous ways.

It essentially comprises a main plate 210, a backing plate 220, and a connection strip 230 interconnecting the two plates 210 and 220.

The tube 110 is secured to the outside surface of the main plate 210, with the axis 112 being orthogonal to the mean plane of said plate.

More precisely, the tube 110 is preferably substantially flush with the free edge of the main plate 210 that defines the opening of the clip, i.e. the edge of the main plate 210 furthest from the connection strip 230.

The outside surface of the tube 110 may be of any shape. As shown in the figures, it is preferably circularly cylindrical.

The tube 110 has an internal channel 120. This channel opens out at least in the end of the tube 110 that is secured to the plate 210. The tube 110 may be blind, i.e. it need not open out at the end of the tube 110 that is remote from the main plate 210. Nevertheless, in the preferred embodiment shown in the accompanying figures, the channel 120 is a through channel, i.e. it opens out to both ends of the tube 110.

The channel 120 is designed to receive a complementary fastener member of the screw type, e.g. a metal or sheet metal screw or a screw made of soft material, a pin, a bolt, a ¼-turn fastener member, or any equivalent means, i.e. in general any fastener member having a flared head and a shank suitable for being engaged and held in a matching appropriate complementary tube.

In this respect, the channel 120 may possess a surface that is smooth, being circularly cylindrical, or a right-section that is polygonal, if the complementary fastener member is self-tapping or self-locking. It may also be tapped or it may possess an array of ribs or fluting suitable for preventing the complementary fastener member from moving.

In order to facilitate manufacture, and more particularly unmolding of the device, the channel 120 presents a certain amount of draft, i.e. it flares slightly towards the end of the tube 110.

By way of non-limiting example, the outside diameter of the tube 110 may be about 8 millimeters (mm), the mean inside diameter of the channel 120 may be about 3 mm, and the height of the tube 110 considered parallel to the axis 112 is typically about 9 mm.

The main plate 210 is preferably plane.

It is defined by two rectilinear side edges 211, 212 that are parallel to each other and orthogonal to the connection strip 230, a free opening edge 213 preferably in the shape of a convex semicylindrical facet centered on the axis 112, and a rectilinear edge that connects with the connection strip 230.

By way of non-limiting example, the diameter of the facet 213 and thus the distance between the two side edges 211 and 212 is about 10 mm and the length of the edges 211 and 212 is about 8 mm. The thickness of the plate 210 (and that of the backing plate 220 and of the connection strip 230) is typically about 1 mm.

Naturally, the main plate 210 possesses an orifice 218 in alignment with the channel 120.

The backing plate 220 presents a non-rectilinear shape that is convex towards the tube 110.

Still more precisely, and as shown in the accompanying figures, the backing plate 220 is preferably curved in shape, being convex towards the tube 110. Thus, advantageously, the backing plate 220 comprises a circular cap centered about an axis orthogonal to the axis 112 and parallel to the connection strip 230.

At rest, the radius of curvature of the backing plate 220 is typically of the order of 20 mm.

The backing plate 220 possesses a through slot 228 for receiving the fastener member. The slot 228 is thus placed in register with the channel 120 and is centered thereon. Its shape and dimensions are adapted to avoid interacting with the complementary fastener member, such as a screw, engaged on the device during assembly, and regardless of the thickness of the part that is placed and clamped within the clip 200, and thus regardless of the amount of deformation of the backing plate 220.

The slot 228 is elongate in a direction parallel to the side edges 211, 212, i.e. perpendicularly to the connection strip 230.

Typically the slot 228 is thus defined by two mutually parallel rectilinear segments 2280 and 2281 that are orthogonal to the connection strip 230, and two end caps 2282 and 2283 that are concave and semicylindrical.

The distance between the two segments 2280 and 2281, and thus the diameter of curvature of the caps 2282 and 2283 is not less than the diameter of the channel 120. It is thus typically about 3 mm. The maximum length of the slot 228 is typically about 6.5 mm.

The backing plate 220 is defined by two rectilinear side edges 221 and 222 that are parallel to each other and orthogonal to the connection strip 230, a free opening edge 223 preferably constituted by a convex semicylindrical facet centered on the axis 112, and two auxiliary segments 224 and 225 which connect the side edges 221 and 222 with a rectilinear edge that connects with the connection strip 230.

The two auxiliary segments 224 and 225 converge towards the connection strip 230. Thus, the backing plate 220 presents a mean width (considered parallel to the connection strip 230) that is greater than that of the plate 210.

This disposition performs a keying function while the device is being put into place. For example, in order to ensure that the device is mounted in one direction only, it suffices for one of the two parts for assembling together to be provided with a groove that is of a width that lies between the width of the plate 210 and the width of the backing plate 220.

Furthermore, and as can be seen on comparing FIGS. 9 and 10, the presence of two converging segments 224, 225 serves to limit the total overall size of the device when the device is pivoted relative to the side edge of the part for fastening so that the connection strip 230 is no longer parallel to said side edge. In FIG. 10, the saving in space (compared with a variant in which the backing plate 220 is of constant width), is referenced G.

By way of non-limiting example, the diameter of the facet 223 and thus the distance between the two side edges 221 and 222 is about 14 mm, the length of the side edges 221 and 222 is about 8 mm, and the length of the segments 224 and 225 is advantageously about 8 mm.

The connection strip 230 is preferably a continuous strip that is generally plane. Advantageously, the strip 230 at rest is inclined relative to the axis 112. It diverges relative thereto going towards the backing plate 220. Typically, the angle of inclination at rest between the connection strip 230 and the axis 112 is about 10°. Thus, at rest, the connection strip 230 advantageously forms an acute angle relative to the backing plate 220 and an obtuse angle relative to the main plate 210.

The height of the connection strip 230 measured between its two connection zones with the plate 210 and the backing plate 230 is typically about 6 mm.

The connection zones 232 and 234 between the connection strip 230 and the plate 210 and the backing plate 220 respectively are advantageously formed by cylindrical caps that are concave towards the center of the clip 200 and centered on respective axes that are orthogonal to the axis 112 and parallel to the connection strip 230.

In the particular and non-limiting embodiment shown in the accompanying figures, the device is provided at its connection strip 230, and more precisely on the outside surface thereof and in the vicinity of each of its two connection zones 232 and 234, with two semicylindrical beads 235 and 236 for acting as bearing points for ejectors in order to make it easier to extract from the mold.

The main plate 210 is advantageously provided on its inside surface with projecting means 240 suitable for retaining the part inserted in the clip and for centering the device relative to the through hole formed in the part for fastening.

In the preferred embodiment shown in the accompanying figures, this retaining means 240 is formed by a stud centered on the axis 112.

The stud is designed to take up a position in a hole or the equivalent formed in the part for assembling onto which the clip 200 is to be positioned.

More precisely, the stud 240 is defined by a circularly cylindrical peripheral surface 242 centered on the axis 112, and a plane end facet 244 orthogonal to the axis 112 and truncated by a plane 246 directed towards the opening of the clip and converging towards the main plate 210 when going towards the opening outline of the clip 200.

Naturally, the outside diameter of the stud 240 should be not less than the diameter of the hole formed in the part that is to be assembled.

The plane 246 thus constitutes a ramp that makes it easier to engage the device on the part for assembly and limits the amount of force required for mounting purposes.

The portion of the stud 240 that is directed towards the connection strip 230 serves to bear against the side of the hole formed in the part for assembly once the stud has been put into place, thereby preventing the device from being removed freely, and thus constituting an anti-loss system.

It should be observed that the two opening facets 213 and 223 of the plates 210 and 220 are truncated. They thus define two chamfers 214 and 224 which diverge towards the outside of the clip, thereby further facilitating engagement of the device on the part for assembly and limiting the force required for mounting it.

According to another characteristic of the present invention, the free height H1 available at rest between the two plates 210 and 220 (i.e. the shortest distance between the two plates 210 and 220) is advantageously ≧1.5 mm.

Furthermore, the height H2 of the opening outline of the clip, measured between the two free edges of the plates 213 and 223 is typically of the same order of magnitude as the height of the connection strip 230, and is advantageously at least ≧2H1, and most preferably ≧3H1.

In order to use the device in accordance with the present invention, the procedure is essentially as follows.

Initially, as shown in FIG. 6, the clip-on nut is put into place on a first part 300. To do this, the clip 200 is engaged on the side edge of the part 300. It should be observed that the connection strip serves as an abutment during this operation, limiting the extent to which the clip-on nut can move over the part 300. In this context, and in non-limiting manner, the distance between the axis 112 of the tube 110 and the inside face of the connection strip 230 is advantageously about 7.5 mm. The stud 240 is then positioned in the hole in the part 300 and is retained therein.

Thereafter, the second part 400 is placed in register with the backing plate 220 parallel to the first part 300 with its own hole being in alignment on the axis 112. The complementary fastener member, e.g. a screw 500, is then engaged through the holes in the two parts 300 and 400 and into the clip-on nut, so as to engage the tube 110 as shown in FIG. 7.

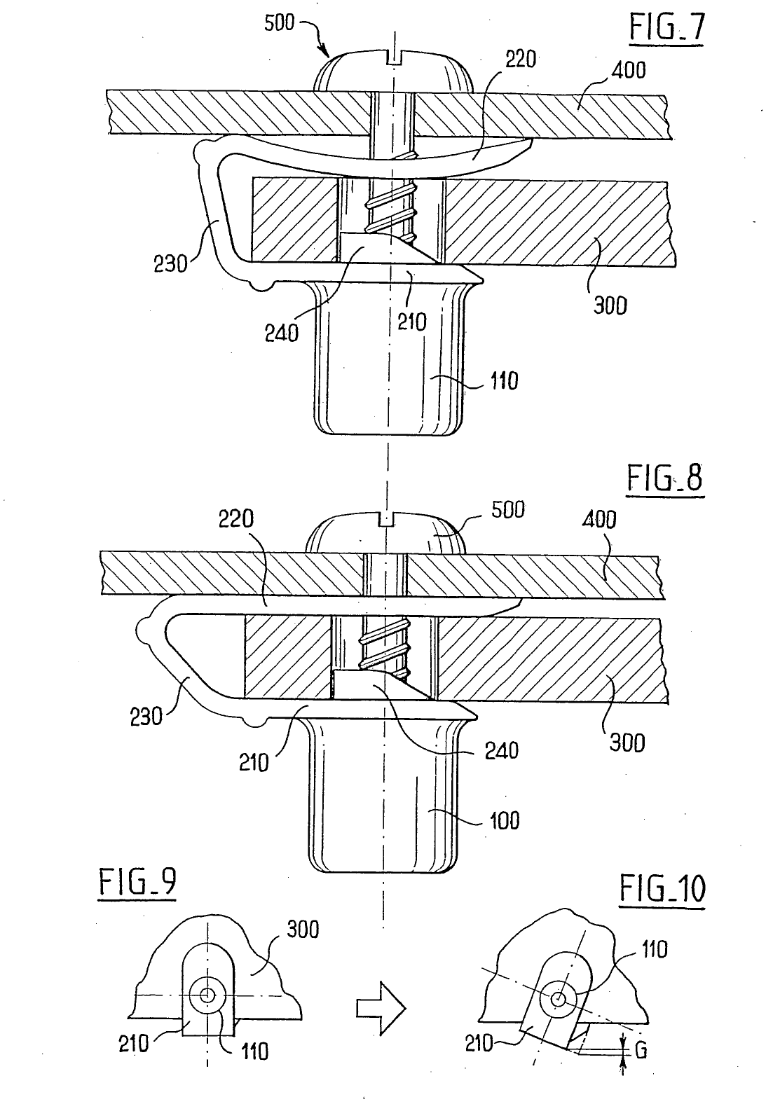

The complementary fastener member 500 may be tightened to any appropriate extent. As shown in FIG. 8, when sufficient force is applied to the clip-on nut, the connection strip 230 tilts progressively more and more relative to the axis 112 and the backing plate 220 becomes flattened. In the context of the present invention, the clip thus deforms like a deformable parallelogram, i.e. the mean planes of the two plates 210 and 220 can remain accurately parallel to each other, with the two plates 210 and 220 pivoting relative to the connection strip 230 in their respective connection zones 232 and 234.

Thus, on being tightened, the device in accordance with the present invention makes it possible to cause the backing plate 220 to be made accurately plane, it enables the two parts 300 and 400 to be accurately parallel, and it holds them together firmly without deforming the main plate 210, and it thus holds the tube 110 accurately orthogonal to the plate 210. The device in accordance with the present invention thus serves to avoid any offset, tilting, or shifting of the complementary fastener member 500.

When the backing plate 220 is in the plane state, the total thickness of the device is equal to the sum of the thickness of the assembled part 300 plus the thicknesses of the two plates 210 and 220. This thickness can thus be considerably smaller than the height of the connection strip 230, even though as a general rule, previously known devices occupy space that is at least equal to the height of the connection strip of their respective clips.

The dimensional values of the device as given above are not limiting in any way. They serve typically to enable the device to be mounted on a part 300 of thickness lying in the range 2.3 mm to 5.5 mm.

The present invention thus enables a single device, i.e. a single reference, to replace the plurality of prior art devices that would otherwise be required when parts of different thicknesses are involved.

Naturally, the present invention is not limited to the particular embodiment described above, but extends to any variant within its spirit.

For example, and where appropriate, the connection strip 230 may be perforated, at least in part.

The above description relates to a connection strip 230 that is generally plane and that does not itself deform significantly under the effect of the applied tightening, while its connection zones 232 and 234 are adapted to be subjected to deformation and to allow the device to work as a deformable parallelogram so that the plates 210 and 220 remain mutually parallel. In a variant, in the context of the present invention, it is possible to use a deformable connection strip for keeping the plates 210 and 220 parallel. For example, in this respect the connection strip 230 may be curved or constituted by two elements that are symmetrical about a plane parallel to the main plate 210, so as to form an obtuse (or an acute) angle relative to said plane. Such a disposition can enhance the reduction in vertical size (measured along the axis of the tube) when a force is exerted on the backing plate 220 along the axis of the tube.

The device may be made to have a clearly distinctive color (white) so as to be contrasted relative to the parts that are to be fastened together, thus acting as an indicator of its own presence.

1. A fastener device comprising a clip (200) and a fastener element (100), the clip (200) being formed by a main plate (210) and a backing plate (220) interconnected by a connection strip (230), and the fastener element (100) comprising a tube (110) secured to the main plate (210) and provided with an internal channel (120), the device being characterized by the fact that, at rest, the backing plate (220) is of non-rectilinear shape being convex towards the tube (110).

2. A device according to claim 1, characterized by the fact that the backing plate (220) is adapted to accept deformation into the plane state under mechanical stress.

3. A device according to claim 1 or claim 2, characterized by the fact that it is formed by a single piece of molded plastics material.

4. A device according to any one of claims 1 to 3, characterized by the fact that it is made of polyoxymethylene.

5. A device according to any one of claims 1 to 4, characterized by the fact that it is made of a material that allows elastic deformation to take place locally.

6. A device according to any one of claims 1 to 5, characterized by the fact that the internal channel (120) of the tube (110) opens out at least to the inside of the clip (200).

7. A device according to any one of claims 1 to 6, characterized by the fact that the internal channel (120) of the tube (110) is adapted to receive a complementary fastener member (500) of the screw type, e.g. a metal screw or a sheet metal screw or a screw of soft material, a pin, a bolt, a ¼-turn fastener member, or any equivalent means, i.e. in general terms any fastener member having a flared head and a shank suitable for being engaged and held in the tube.

8. A device according to any one of claims 1 to 7, characterized by the fact that the internal channel (120) of the tube possess a smooth surface.

9. A device according to any one of claims 1 to 7, characterized by the fact that the internal channel (120) of the tube is tapped.

10. A device according to any one of claims 1 to 9, characterized by the fact that the internal channel (120) of the tube (110) presents draft, flaring slightly towards the end of the tube (110).

11. A device according to any one of claims 1 to 10, characterized by the fact that the main plate (210) possesses an orifice (218) in alignment with the channel (120) of the tube.

12. A device according to any one of claims 1 to 11, characterized by the fact that the backing plate (220) is of curved shape being convex towards the tube (110).

13. A device according to any one of claims 1 to 12, characterized by the fact that the backing plate (220) is formed by a circular cap centered about an axis orthogonal to the axis (112) of the tube and parallel to the connection strip (230).

14. A device according to any one of claims 1 to 13, characterized by the fact that the backing plate (220) possesses a through slot (228) for receiving the complementary fastener member.

15. A device according to claim 14, characterized by the fact that the slot (228) is of shape and dimensions adapted to avoid interacting with the complementary fastener member, regardless of the thickness of the part placed and clamped in the clip (200), and thus regardless of the extent to which the backing plate (220) is deformed.

16. A device according to claim 14 or claim 15, characterized by the fact that the slot (228) is elongate in a direction perpendicular to the connection strip (230).

17. A device according to any one of claims 1 to 16, characterized by the fact that the two plates (210, 220) are of different widths.

18. A device according to any one of claims 1 to 17, characterized by the fact that the backing plate (220) is wider than the main plate (210).

19. A device according to any one of claims 1 to 18, characterized by the fact that the backing plate (220) is connected to the connection strip (230) by two segments (224, 225) that converge towards the connection strip (230).

20. A device according to any one of claims 1 to 19, characterized by the fact that the connection strip (230) at rest is inclined relative to the axis (112) of the tube (110).

21. A device according to any one of claims 1 to 20, characterized by the fact that the connection strip (230) diverges relative to the axis (112) of the tube (110) going towards the backing plate (220).

22. A device according to any one of claims 1 to 21, characterized by the fact that the main plate (210) is provided on its inside surface with projecting means (240) suitable for holding the part that is inserted in the clip and for centering the device relative to a through hole formed in the part for fastening.

23. A device according to claim 22, characterized by the fact that the retaining means (240) is formed by a stud centered on the axis (112) of the tube.

24. A device according to claim 23, characterized by the fact that the stud (240) is defined by an end facet (244) that is truncated by a plane (246) directed towards the opening of the clip and that converges towards the main plate (210) going towards the opening outline of the clip (200).

25. A device according to claim 23 or claim 24, characterized by the fact that the portion of the stud (240) directed towards the connection strip (230) serves as an abutment against the edge of the hole formed in the part for assembly once the stud has been put into place so as to prevent the device from being removed freely.

26. A device according to any one of claims 1 to 25, characterized by the fact that the opening facets (213, 223) of the plates (210, 220) are truncated and define chamfers (214, 224) that diverge towards the outside of the clip.

27. A device according to any one of claims 1 to 26, characterized by the fact that the free height (H1) available at rest between the two plates (210, 220) is ≧1.5 mm.

28. A device according to any one of claims 1 to 27, characterized by the fact that the height (H2) of the opening outline of the clip, measured between the two free edges (213, 223) of the plates (210, 220) is of the same order of magnitude as the height of the connection strip (230).

29. A device according to any one of claims 1 to 28, characterized by the fact that the height (H2) of the opening outline of the clip, measured between the two free edges (213, 223) of the plates (210, 220) is at least ≧2H1.

30. A device according to any one of claims 1 to 29, characterized by the fact that the height (H2) of the opening outline of the clip, measured between the two free edges (213, 223) of the plates (210, 220) is at least ≧3H1.

31. A device according to any one of claims 1 to 30, characterized by the fact that the two connection zones (232, 234) between the connection strip (230) and each of the two plates (210, 220) respectively are adapted to be subjected to deformation such that under stress the connection strip (230) tilts progressively and the clip deforms like a deformable parallelogram, the two plates (210, 220) remaining accurately parallel to each other.

32. A device according to any one of claims 1 to 30, characterized by the fact that the connection strip (230) is deformable so as to enable the main plate (210) and the backing plate (230) to be maintained generally parallel.

33. A device according to any one of claims 1 to 32, characterized by the fact that it is made to have a distinctive color forming contrast relative to the parts to be fastened together, so as to act as an indicator of its own presence.
